(19) United States
(12) Patent Application Publication
(10) Pub. No.: US 2026/0359219 A1
(43) Pub. Date: Nov. 12, 2026

(54) TRANSPARENT MEMORY OPERATIONS

(71) Applicant: MELLANOX TECHNOLOGIES, LTD., Yokneam (IL)

(72) Inventors: Vishwanath Venkatesan, Austin, TX (US); Moein Khazraee, Sunnyvale, CA (US); Subhadeep Bhattacharya, Santa Clara, CA (US); Timothy Paul Stamler, Austin, TX (US); Adit Uday Ranadive, Palo Alto, CA (US); Omri Kahalon, Calgary (CA); Artem Yuryevich Polyakov, New York, NY (US); Kapil Arya, Woodinville, WA (US)

(21) Appl. No.: 19/641,329

(22) Filed: Apr. 7, 2026

Related U.S. Application Data
(60) Provisional application No. 63/802,487, filed on May 8, 2025.

(51) Int. Cl. G06F 12/0802

(52) U.S. Cl. CPC G06F 12/0802; G06F 2212/60

(57) ABSTRACT

A system is described that includes an abstraction layer that facilitates data movement between different types of storage endpoints. The abstraction layer may enable both context workers and generation workers in a Large Language Model (LLM) to move data between different storage endpoints, substantially transparently to a user. The different storage endpoints may be defined as plugins to the abstraction layer to enable movement of data between the storage endpoints.

### CROSS-REFERENCE TO RELATED APPLICATIONS

The present application claims the benefit of and priority, under 35 U.S.C. § 119, to U.S. Provisional Application Serial No. 63/802,487, filed May 8, 2025, entitled “STORAGE ACCESS FOR TRANSPARENT UNIFIED ONE SIDED MEMORY OPERATIONS FOR DISTRIBUTED SYSTEM,” the entire disclosure of which is hereby incorporated herein by reference, in its entirety, for all that it teaches and for all purposes.

### BACKGROUND

Traditional Large Language Model (LLM) deployments placed both the prefill and decode phases of inference on a single Graphics Processing Unit (GPU) or node, despite each phase having different resource requirements. This approach hindered performance optimization and prevented full utilization of GPU resources.

The prefill phase processes user input to generate the first output token and is compute-bound, while the decode phase generates subsequent tokens and is memory-bound. Co-locating these phases on the same GPU or GPU node leads to inefficient resource use, especially for long input sequences. Additionally, the distinct hardware needs of each phase limit model parallelism flexibility, causing missed performance opportunities.

Inference frameworks, such as LLM deployments, may utilize a high-performance, low-latency transfer library to improve the operations thereof. Enhanced performance of the transfer library has a direct impact on the performance of the LLM models.

Distributed Key-Value (KV) caching presents a mechanism for managing the transfer of during inference to store and reuse previous token computations, usually with an aim towards improving inference performance vis-à-vis reduced latency. Traditional KV cache data is usually required to be stored in some long-term storage medium to avoid re-computation later, which has a negative impact on performance.

### GENERAL DESCRIPTION

Embodiments of the present disclosure contemplate improved systems, methods, and devices to address the above-noted shortcomings of LLM deployments. More specifically, in some embodiments, a high-performance, low-latency transfer library is provided herein that supports improved operations of inference services. It should be appreciated that a transfer library, as depicted and described herein, can be used in connection with network and/or storage data transfers.

Aggregated and disaggregated services are described herein that utilize an improved transfer library to transparently and efficiently manage data storage for such services. An aggregated service may implement prefill and decode phases onto a common GPU or node whereas a disaggregated service may separate the prefill and decode phases onto different GPUs or nodes. Either or both services benefit from improvements in the transfer library that manages data storage and transfers between the phases.

In a non-limiting example, low tensor parallelism can be used in the prefill phase to reduce communication overhead, while high tensor parallelism can improve memory operations in the decode phase. The separation of the prefill phase from the decode phase benefits significantly from an improved management of tokens. Embodiments of the present disclosure contemplate a transfer library to operate as a "transfer engine" for inference services that makes advanced, distributed Key-Value (KV) caching strategies possible, allowing inference systems to scale efficiently. A high-performance transfer library according to embodiments of the present disclosure is designed for efficient, low-latency movement of KV cache data in distributed, large-scale inference environments. The transfer library may be configured to operate as a backend for LLM environments to handle complex data transfers between prefill (e.g., context processing) and decode (e.g., generation) workers, particularly when using disaggregated serving architectures. Utilization of a transfer library offering such improvements can help facilitate more efficient resource allocation, reduced inference-serving costs, and better control over service-level objectives (SLOs) such as Time-To-First Token (TTFT) and Inter-Token Latency (ITL).

In accordance with at least some embodiments, a high-throughput, low-latency open-source inference serving framework is provided for deploying generative Artificial Intelligence (AI) and reasoning models in large-scale distributed computing environments. The framework can significantly boost the number of requests served, especially when utilizing the transfer library provided herein. Benefits provided may include, without limitation:
Increased throughput per GPU/node
Improvements to dynamic scheduling of GPUs/nodes based on fluctuating demand to optimize performance
Accelerated asynchronous data transfer between GPUs/nodes to reduce inference response time
KV cache offloading across different memory hierarchies to increase system throughput

In KV caches, the Key (K) and Value (V) may correspond to states of generative transformers that are cached together. KV caching may occur during multiple token generation steps and traditionally happens in the decoder. Thus, decoder-only models or decoder parts of an encoder-decoder model like will often use KV caching.

KV caches in many LLMs are a common optimization for an inference process to help an attention mechanism to scale linearly rather than quadratically. Specifically, KV caches can spare the recompute of Key and Value tensors of past tokens at each generation by trading memory against compute. In some embodiments, a KV cache is used to store the intermediate K and V vectors for all previous tokens in a Transformer model, formatted as tensors with dimensions following a predetermined structure. The K and V vectors in the KV cache may be structured as [batch_size, num_heads, sequence_length, head_dim] (or [seq_len, batch, heads, head_dim]). These matrices, cached per layer, allow the model to avoid recomputing attention scores for past tokens during autoregressive generation.

In some embodiments, the K and V vectors may correspond to tensors having dimensions of N x dₖ (Keys) and N x dᵥ (Values) per layer, where N is the sequence length and d is the head dimension. During decoding, the K and V vectors for a single new token may be computed and appended (e.g., concatenated) to the existing cache along the sequence dimension. In Multi-Head Attention (MHA), each query head has its own KV pair. In Grouped-Query Attention (GQA) or Multi-Query Attention (MQA), multiple query heads share a single set of KV pairs, reducing the cache size. For optimization, KV cache tensors can be quantized to lower precision (e.g., FP8, INT8) to reduce memory bandwidth requirements.

In an LLM serving pipeline and in accordance with at least some embodiments of the present disclosure, a KV cache manger is configured to handle the extension of the GPU memory level across different types of memory creating a cache hierarchy for storing and retrieving the KV caches. Embodiments of the present disclosure provide a transfer library that helps data movement between memories of different processing nodes (e.g., between Central Processing Units (CPUs) and Graphics Processing Units (GPUs)) to persistent storage layers such as block storage/parallel and distributed file systems. As discussed above and in accordance with at least some embodiments, a high-throughput, low-latency point-to-point transfer library is provided that presents a consistent data movement API to move data rapidly and asynchronously across different tiers of memory and storage using common semantics. The framework may be optimized for inference data movement, supporting nonblocking and noncontiguous data transfers between various types of memory and storage. The use of KV caching with a transfer library according to embodiments of the present disclosure extends the GPU memory further, to a point where a storage layer backed with Petabytes (PBs) of storage for accessing the KV cache.

A set of storage backend plugins are also described to allow the transparent movement of data between different types of storage types such as file, block, and object without the application having to handle the issues associated with such data movements. The abstraction and transparent mapping between the different types of storage facilitates ease of data movement between different storage types and storage layers in remote storage. Abstraction of the data movement by the transfer library further enhances the overall performance of the LLM serving pipeline.

Embodiments of the present disclosure present a solution to provide a substantially uniform abstraction facilitating data movement between different types of storage endpoints such as block, local file, remote file, remote object, and cloud endpoints. Such an abstraction allows context and generation workers to move data between different endpoints seamlessly. The different storage endpoints may be defined as plugins to a transfer abstraction that can enable such data movement with just defining a single API, which can help abstract such data movement.

According to embodiments, a system is provided that includes: a Key and Value (KV) cache store having an abstraction layer facilitating data movement between different types of storage endpoints.

In some aspects, the abstraction layer enables both context workers and generation workers in a Large Language Model (LLM) to move data between different storage endpoints.

In some aspects, the different storage endpoints are defined as plugins to the abstraction layer to enable the movement of data between the storage endpoints.

In some aspects, the different storage endpoints include at least one of block endpoints, local file endpoints, remote file endpoints, remote object endpoints, and cloud endpoints.

In some aspects, the KV cache includes at least one of a memory pool, a block storage, file storage, and an object storage.

According to further embodiments, a transfer library is provided that includes: a Key and Value (KV) cache; and an abstraction layer that utilizes the KV cache to facilitate transparent data movement for context workers and generation workers in a Large Language Model (LLM).

In some aspects, a cache manager cooperates with an inference transfer engine to move data for the context workers and for the generation workers between different storage endpoints depending upon a predicted need for such data.

In some aspects, the KV cache includes a distributed KV cache that includes at least one of a memory pool, a block storage, a file storage, and an object storage.

In some aspects, the KV cache stores intermediate states of inference generated by at least one of the context workers and the generation workers.

In some aspects, the context workers and the generation workers are executed on different processing nodes.

In some aspects, the different processing nodes include at least one of a Graphics Processing Unit (GPU), a Central Processing Unit (CPU), a Data Processing Unit (DPU), and a Quantum Processing Unit (QPU).

In some aspects, the abstraction layer is implemented as a transfer agent having a first Application Programming Interface (API) to manage requests and completions and a second API to manage interactions with the KV cache.

In some aspects, the context workers perform a prefill phase of inference and the generation workers perform a decode phase of inference and wherein the LLM comprises at least one of a generative Large Language Model (LLM) and a reasoning model.

According to further embodiments, a computing environment is provided that includes: a Key and Value (KV) cache; one or more models to provide an inference service; and a cache manager that transparently performs one-sided operations for the one or more models using the KV cache to facilitate network-related data transfers and storage-related data transfers across different storage endpoints.

In some aspects, the one or more models are distributed across a plurality of different nodes.

In some aspects, the one or more models provide a prefill phase of inference and a decode phase of inference.

In some aspects, the cache manager utilizes the KV cache to offload the network-related data transfers and the storage-related data transfers across different memory hierarchies.

In some aspects, the different memory hierarchies include at least a first memory hierarchy and a second memory hierarchy, where the first memory hierarchy includes a first capacity and a first retrieval speed associated therewith, where the second memory hierarchy includes a second capacity and a second retrieval speed associated therewith, where the first capacity is less than the second capacity, and where the first retrieval speed is faster than the second retrieval speed.

In some aspects, the different storage endpoints are provided as different transfer backend plugins that are accessible to the cache manager via an Application Programming Interface (API) that defines a structure for the one-sided operations.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/implementations in combination with any one or more other aspects/features/implementations.

Use of any one or more of the aspects or features as disclosed herein.

It is to be appreciated that any feature described herein can be claimed in combination with any other feature(s) as described herein, regardless of whether the features come from the same described implementation.

The details of one or more aspects of the disclosure are set forth in the accompanying drawings and the description below. Other features, objects, and advantages of the techniques described in this disclosure will be apparent from the description and drawings, and from the claims.

Numerous additional features and advantages of the present disclosure will become apparent to those skilled in the art upon consideration of the implementation descriptions provided hereinbelow.

Additional features and advantages are described herein and will be apparent from the following description and the figures.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a server system in accordance with at least some embodiments.

FIG. 2 depicts a processing system in accordance with at least some embodiments.

FIG. 3 depicts a computing environment in accordance with at least some embodiments.

FIG. 4 is a block diagram illustrating details of a disaggregating service in accordance with at least some embodiments.

FIG. 5 is a block diagram illustrating details of a transfer library in accordance with at least some embodiments.

FIG. 6 is a block diagram illustrating details of a planner used to manage an inference service in accordance with at least some embodiments.

FIG. 7 is a block diagram illustrating memory hierarchies in accordance with at least some embodiments.

FIG. 8 is a block diagram illustrating further details of a cache manager in accordance with at least some embodiments.

FIG. 9 illustrates details of a first processing method in accordance with at least some embodiments.

FIG. 10 illustrates details of a second processing method in accordance with at least some embodiments.

FIG. 11 is a flow diagram illustrating an example method of operating a transfer library in accordance with at least some embodiments.

FIG. 12 is a block diagram illustrating a parallel processing unit in accordance with at least some embodiments.

FIG. 13 illustrates an example data center used to provide an inference service in accordance with at least some embodiments.

FIG. 14 illustrates components of a data center in accordance with at least some embodiments.

### DETAILED DESCRIPTION

A transfer library is depicted and described herein to support operations of an inference service. As can be appreciated, the various aspects of the transfer library may help improve operations of an aggregated inference service (e.g., a service in which a common processing node handles prompt prefill phases and token decoding phases computation), a disaggregated inference service (e.g., a service in which different processing nodes handle the prompt prefill phases and the token decoding phases), or the like. Use of a transfer library as described herein can help facilitate more efficient resource allocation, manage data transfers is a substantially transparent manner, and support efficient one-sided operations with network-related transfers as well as storage-related transfers.

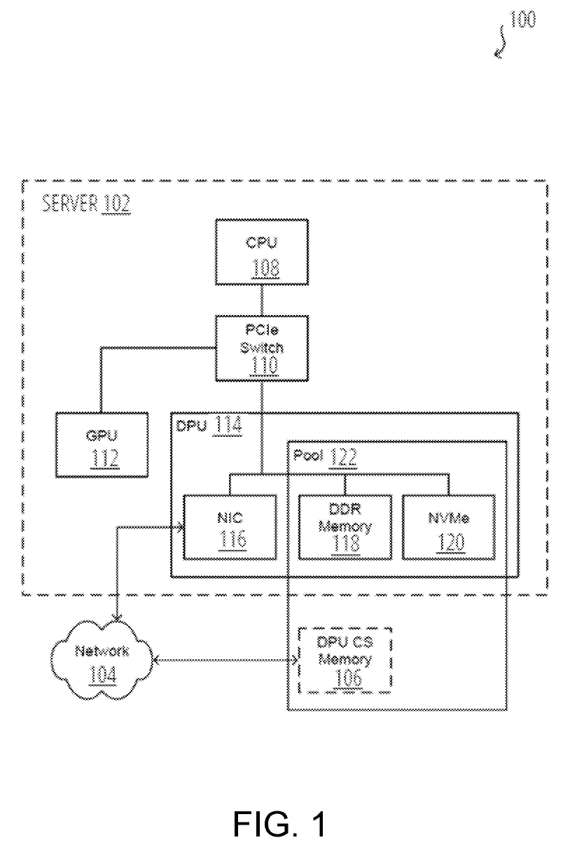

FIG. 1 depicts an example computing environment 100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures.

The example computing environment 100 may include (one or more) server 102 which may be used to perform HPC workloads, such as AI training or machine learning model training. In an embodiment, the server 102 may be an application instance or a compute node. The server 102 may include a CPU 108 associated with a switch 110, such as a peripheral component interconnect express (PCIe) switch, which may control at least some data transmission over communication paths interconnecting various components. In an embodiment, the CPU 108 may include a root complex processor.

The PCIe switch 110 may also be associated with a GPU 112 and a DPU 114, and may transmit data between at least some of the CPU 108, the GPU 112, the DPU 114, and other components. In an embodiment, the PCIe switch 110 may be associated with more than one GPU or more than one DPU. In another embodiment, the PCIe switch 110 may be located within the DPU 114. The PCIe switch 110 may manage the transfer of at least some data between the CPU 108, the GPU 112, and the DPU 114. In another embodiment, the number of GPUs associated with the PCIe switch 110 may be equal to the number of DPUs associated with the PCIe switch 110. In at least one embodiment, the server 102 may include, without limitation, any number of the CPUs 108, the PCIe switches 110, the GPUs 112, and/or the DPUs 114, in any combination. For example, in at least one embodiment, server 102 could include eight, sixteen, thirty-two, and/or more GPUs 112.

In at least one embodiment, communication paths interconnecting various components, including but not limited to the CPU 108, the PCIe switch 110, the GPU 112, and the DPU 114, in FIG. 1 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 114 may include a network interface card (NIC) 116, a DDR memory 118, and a non-volatile memory express (NVMe) device 120. The NIC 116 may be able to interface with a network 104, which may also interface with additional NVMe devices available to the DPU 114, such as over fabric. In an embodiment, the DPU 114 may not include the NVMe device 120. In another embodiment, the NVMe device 120 may be located on the server 102 and not on the DPU 114.

In yet another embodiment, the computing environment 100 may include more than one of the NVMe device 120, such as a first NVMe device in the DPU 114 and a second NVMe device on the server 102 associated directly with the PCIe switch 110. In an embodiment, the DPU 114 may not include the DDR memory 118 and may include a computational storage services (CSS) in place of, or in addition to, the DDR memory 118. For example, computing environment 100 may include DPU computational storage (CS) memory 106 available to the DPU 114 as part of the CSS. The network 104 may be able to interface with the DPU CS memory 106 through the NIC 116, according to any suitable interface protocol, such as remote direct memory access (RDMA) over Ethernet, InfiniBand, Fiber Channel, etc..

The total memory of the computing environment 100 available for data storage may be expanded through the use of the DPU 114 on nodes of the system. The DPU 114 may have access to a pool 122 of memory already available to the server 102, such as double data rate (DDR) memory, on-board NVMe devices, NVMe devices over fabric, and CS. The pool 122 of memory may include at least one of the DDR memory 118, NVMe device 120, and the DPU CS memory 106.

The DPU 114 may also be able to access the available memory of other DPUs as part of the pool 122, and other DPUs may be able to access the available memory of DPU 114, such as the pool 122 . This available memory can be accessed and utilized for data storage, without the addition of compute resources, such as compute nodes, which would be required using other solutions.

The available pool 122 accessible to the DPU 114 may be provisioned for the server 102 to expand the total memory available for data storage, such as to reduce the data storage load on the CPU 108 or the GPU 112, which can instead increase the utilization of their memory for processing. For example, during training of an AI, the model states, residual states, activation functions, and checkpoints can be stored, or offloaded, on the pool 122 accessible to the DPU 114.

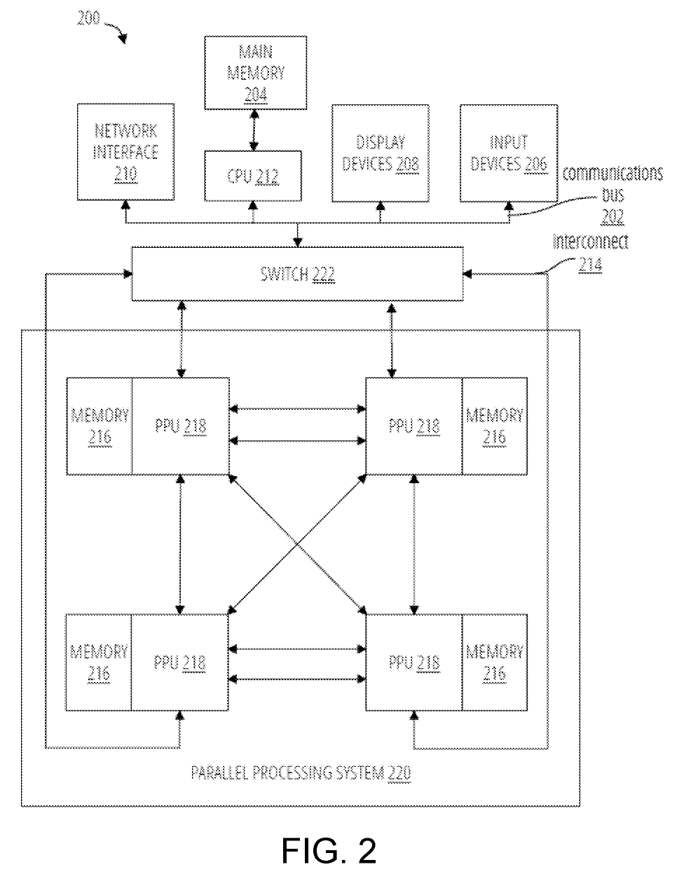

FIG. 2 depicts a computer system 200, according to at least one embodiment. In at least one embodiment, computer system 200 is configured with components such as multiple parallel processing units that utilize one or more bridge boards.

In at least one embodiment, computer system 200 comprises, without limitation, at least one central processing unit (“CPU”) 212 that is connected to a communications bus 202 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 200 includes, without limitation, a main memory 204 and control logic (e.g., implemented as hardware, software, or a combination thereof) and data are stored in main memory 204 which may take form of random-access memory (“RAM”). In at least one embodiment, a network interface subsystem (“network interface”) 210 provides an interface to other computing devices and networks for receiving data from and transmitting data to other systems from computer system 200.

In at least one embodiment, computer system 200 includes, without limitation, input devices 206, parallel processing system 220, and display devices 208 which can be implemented using a conventional cathode ray tube (“CRT”), liquid crystal display (“LCD”), light emitting diode (“LED”), plasma display, or other suitable display technologies. In at least one embodiment, user input is received from input devices 206 such as keyboard, mouse, touchpad, microphone, and more. In at least one embodiment, each of foregoing modules can be situated on a single semiconductor platform to form a processing system.

In at least one embodiment, computer programs in the form of machine-readable executable code or computer control logic algorithms are stored in main memory 204 and/or secondary storage. Computer programs, if executed by one or more processors, enable computer system 200 to perform various functions in accordance with at least one embodiment. Main memory 204, secondary storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 212; parallel processing system 220; an integrated circuit capable of at least a portion of capabilities of both CPU 212; parallel processing system 220; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 200 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 220 includes, without limitation, a plurality of parallel processing units (“PPUs”) 218 and associated memories 216. In at least one embodiment, PPUs 218 are connected to a host processor or other peripheral devices via an interconnect 214 and a switch 222 or multiplexer. In at least one embodiment, parallel processing system 220 distributes computational tasks across PPUs 218 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 218, although such shared memory may incur performance penalties relative to use of local memory and registers resident to a PPU 218. In at least one embodiment, operation of PPUs 218 is synchronized through use of a command such as_syncthreads (), wherein all threads in a block (e.g., executed across multiple PPUs 218 to reach a certain point of execution of code before proceeding.

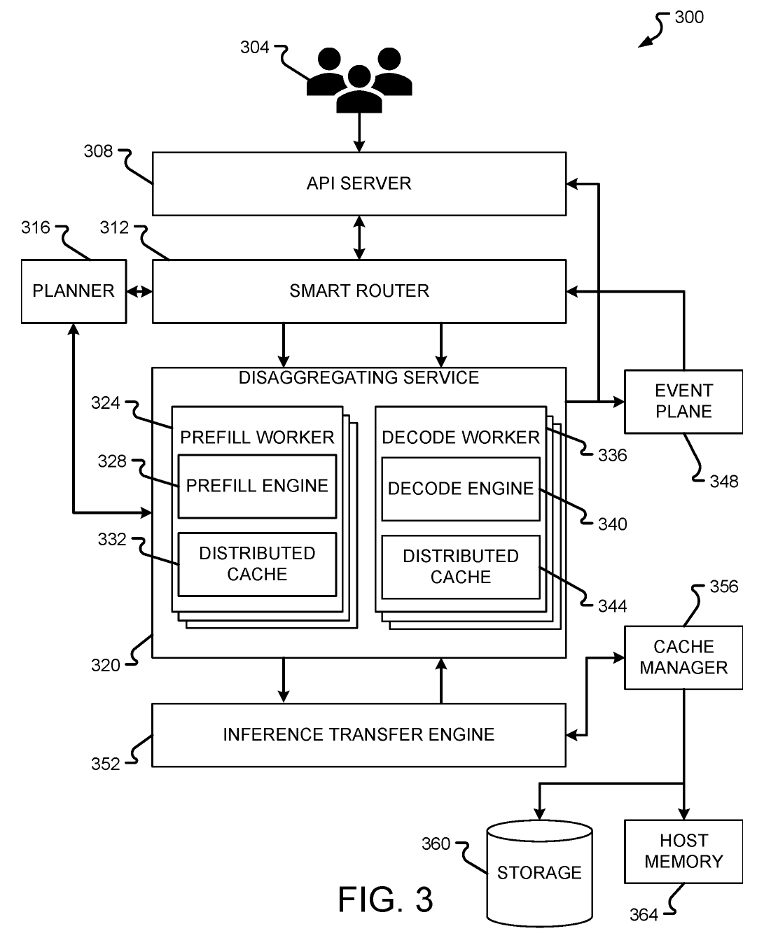

FIG. 3 illustrates additional details of a computing environment 300 in accordance with at least some embodiments of the present disclosure. The computing environment 300 is shown to include an inference service in the form of a disaggregating service 320, but it should be appreciated that the computing environment 300 may alternatively or additionally provide inference services in an aggregated format.

The computing environment 300 is further shown to include an API server 308 that provides users 304 with an interface to the inference services provided by the computing environment 300. The API server 308 is shown as a single server, but it should be appreciated that the functionality of the API server 308 can be delivered with a plurality of servers without departing from the scope of the present disclosure.

The computing environment 300 further includes a smart router 312, a planner 312, a disaggregating service 320, an event plane 348, an inference transfer engine 352, a cache manager 356, and a number of different storage endpoints, which may include object storage 350, host memory 364, and the like.

The disaggregating service 320 is shown to include a plurality of prefill workers 324 and a plurality of decode workers 336 that operate together to provide inference services to the users 304. In some examples, each prefill worker 324 may include at least one prefill engine 328 and a distributed cache 332. Similarly, each decode worker 336 may include at least one decode engine 340 and a distribute cache 344. In some embodiments, the prefill workers 324 may provide prefill phases of inference whereas the decode workers 336 may provide decode phases of inference. Both the prefill workers 324 and decode workers 336 may be instantiated as one or more AI models (e.g., LLMs) to perform the prefill and decode phases of inference, respectively. Depending upon whether the inference service is provided as an aggregated service or disaggregated service, the prefill workers 324 and decode workers 336 may be executed on a single processing node (e.g., when provided as an aggregated service) or a plurality of distributed processing nodes (e.g., when provided as a disaggregated service).

In large-scale distributed and disaggregated-serving inference systems, such as the computing environment 300, efficiently managing processing resources (e.g., CPU resources, GPU resources, etc.) is helpful to maximize throughput and minimize latency. While disaggregated serving can significantly enhance inference throughput and efficiency, it might not always be the most effective solution for every incoming request received at the API server 308.

A scenario may exist where a surge of summarization requests are received from the group of users 304 with long input sequence lengths (ISLs) but short output sequence lengths (OSLs). Such a surge of summarization requests may overwhelm the processing nodes (e.g., GPUs) executing the prefill workers 324. While the processing nodes implementing the decode workers 336 may remain underutilized, the prefill workers 324 and their corresponding processing nodes become a bottleneck. In this case, allowing decode workers 336 to perform both prefill and decode tasks in a traditional aggregated manner, or shifting decode GPUs to perform prefill tasks, might be more efficient. This approach can help balance the load, alleviate pressure on the prefill GPUs, and ultimately improve overall throughput.

Deciding between disaggregated and aggregated serving or how many nodes should be assigned to each phase can depend on several factors. These factors include the time needed to transfer the KV cache between the prefill and decode GPUs, the GPUs’ queue wait times for incoming requests, and the estimated processing times for both disaggregated and aggregated configurations. In large-scale computing environments 300 with hundreds of GPUs, these decisions can quickly become very complex.

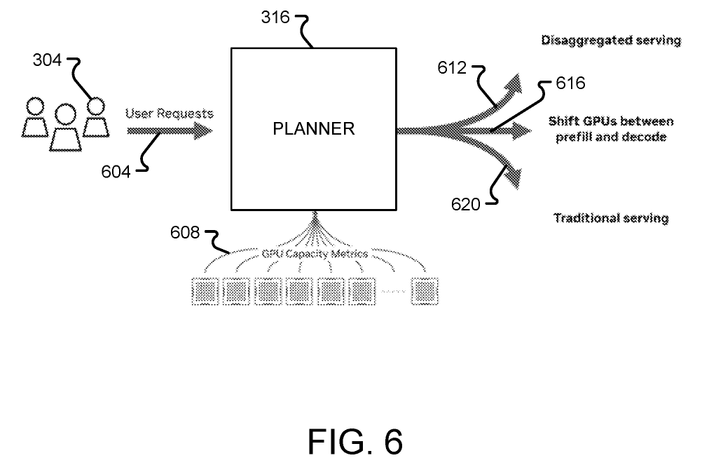

As further detailed in FIG. 6, as user requests 604 are received, the planner 316 may be configured to continuously monitors key GPU capacity metrics 608 received via the event plane 348, and combine them with application SLOs such as TTFT and ITL to make informed decisions on whether to serve incoming requests with or without disaggregation or if additional GPUs should be added to either phase. The planner 316 may, therefore, help ensure that processing resources are allocated efficiently across prefill workers 324 and decode workers 336, adapting to fluctuating workloads while maintaining peak system performance. As a more specific but non-limiting example, the planner 316 may be configured to make decisions on whether a user request 604 should be routed to a disaggregated service 612 (e.g., as shown in FIG. 3), to a traditional service 620 (e.g., an aggregated service), and/or whether processing resources should be shifted 616 between the prefill workers 324 and decode workers 336.

Before responding to a use request 604, LLMs may build a contextual understanding of the input request known as the KV cache. The KV cache may be stored in a distributed fashion (e.g., as a global (distributed) KV cache store), which may include the distributed caches 332 of the prefill workers 324 and the distributed caches of the decode workers 336. The KV cache may be managed by the cache manager 356, which can be configured to transparent perform one-sided operations for the prefill workers 324 and decode workers 336 (e.g., their models) using the KV cache to facilitate data transfers (e.g., network-related data transfers and storage-related data transfers) across different storage endpoints, such as the storage 360 endpoints and host memory 364.

Because the process of generating storing KV caches is compute intensive and scales quadratically with the size of the input request, reusing the KV cache helps avoids the need to recompute it from scratch, reducing inference time and compute resources. This is particularly advantageous in use cases where the same request is frequently executed, such as system prompts, single-user multiturn chatbot interactions, and agentic workflows. The cache manager 356 may be configured to interact with the inference transfer engine 352 and the smart router 312 to intelligently manage data transfers and determine/predict when a KV cache can be reused or is likely to be reusable.

The smart router 312 may be configured to hash incoming requests and stores them in a Radix Tree, which allows the tracking of KV locations in the computing environment 300. The smart router 312 may also utilize one or more algorithms for KV cache insertion and eviction ensuring that the most relevant blocks are retained.

When a new inference request arrives from a user 304, the smart router 312 may be configured to compute an overlap score between incoming requests and the KV cache blocks already active across all the memory of all GPUs in the distributed cluster. By factoring in the overlap score and the distribution of workload across the GPU fleet, the smart router 312 may intelligently route requests to the most suitable workers, minimizing KV cache recomputation while ensuring a balanced load across the cluster.

As previously noted, calculating a KV cache for user requests is resource-intensive and thus expensive. Reusing a KV cache to minimize the need for its recomputation is useful to avoid such an expense. However, as AI demand increases, the volume of KV cache that must be stored in GPU memory for reuse can quickly become prohibitively costly. This creates a significant challenge for inference services trying to efficiently manage KV cache reuse.

Large-scale distributed inference leverages model parallelism techniques such as Tensor, pipeline, and expert parallelism, which rely on internode and intranode, low-latency, high-throughput communication leveraging GPUDirect RDMA. These systems may also require rapid KV cache transfer between prefill workers 324 and decode workers 336, particularly in disaggregated serving environments.

Thus, in accordance with at least some embodiments, the cache manager 356 may cooperate with the inference transfer engine 352 to handle the extension of the GPU memory level across different types of memory creating a cache hierarchy for storing and retrieving the KV caches. The cache manager 356 may facilitate data movement between different CPU and/or GPU memories to persistent storage layers such as memory pools, block storage, a file storage, and/or object storage.

The cache manager 356 may, therefore, be a part of a high-throughput, low-latency point-to-point transfer library that provides a consistent data movement API to move data rapidly and asynchronously across different tiers of memory and storage using the same semantics. The cache manager 356 may cooperate with the inference transfer engine 352 to optimize inference data movement between the prefill workers 324 and decode workers 336, supporting nonblocking and noncontiguous data transfers between various types of memory 364 and storage 360. The use of KV caching with the transfer library allows to extend the GPU memory further to a point where a storage layer backed significant storage capacity (e.g., PBs) can become useful for the storage of KV cache information (e.g., tokens, values, keys, etc.).

Additionally, the cache manager 356 may also support accelerated communication libraries that are both hardware- and network-agnostic, capable of efficiently moving data across GPUs and memory hierarchies including storage—like CPU memory, and block, file, and object storage—and compatible with a range of networking protocols.

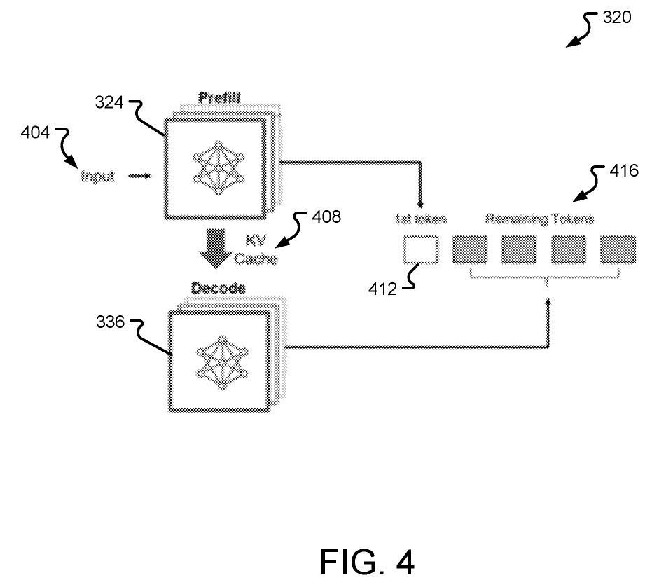

FIG. 4 illustrates additional details of the disaggregating service 320 showing the interactions between the prefill workers 324 and the decode workers 336. More specifically, the prefill workers 324 are shown to receive the initial input 404 (e.g., the inference request from a user 304). As the prefill workers 324 begin processing the input 404, the prefill workers 324 may generate a KV cache 408 that is used to create a first token 412 and that can be shared with a decode worker 336, which generates remaining tokens 416 in parallel with computations generated at the prefill worker 324.

In some embodiments, each of the prefill workers 324 may be executed on dedicated processing nodes (e.g., GPUs, CPUs, DPUs, QPUs, etc.) to improve prefill efficiency. The decode workers 336 may be executed on different processing nodes than the prefill workers 324, particularly in a disaggregated system, such that high tensor parallelism is used to increase memory bandwidth.

In some embodiments, the KV cache 408 may be managed by the cache manager 356. A KV cache 408 may be used to store the intermediate K and V vectors for all previous tokens in a Transformer model, formatted as tensors with dimensions following a predetermined structure. The K and V vectors in the KV cache 408 may be structured as [batch_size, num_heads, sequence_length, head_dim] (or [seq_len, batch, heads, head_dim]). These matrices, cached per layer, allow the model to avoid recomputing attention scores for past tokens during autoregressive generation.

In some embodiments, the K and V vectors may correspond to tensors having dimensions of N x dₖ (Keys) and N x dᵥ (Values) per layer, where N is the sequence length and d is the head dimension. During decoding, the K and V vectors for a single new token 416 may be computed and appended (e.g., concatenated) to the existing KV cache 408 along the sequence dimension. In Multi-Head Attention (MHA), each query head has its own KV pair. In Grouped-Query Attention (GQA) or Multi-Query Attention (MQA), multiple query heads share a single set of KV pairs, reducing the cache size. For optimization, KV cache tensors can be quantized to lower precision (e.g., FP8, INT8) to reduce memory bandwidth requirements.

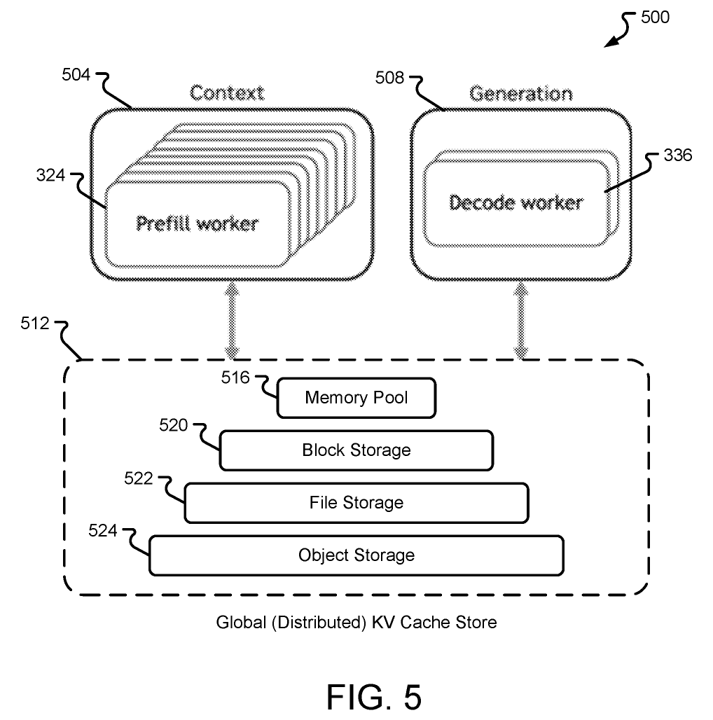

As shown in FIG. 5, a transfer library 500 may include a global (distributed) KV cache store 512 that is shared between the context phase 504 and the generation phase 508 of the inference service. FIG. 5 also illustrates that the prefill workers 324 may be used within the context phase 504 to perform a prefill phase of inference while the decode workers 336 are used within the generation phase 508 to perform a decode phase of inference.

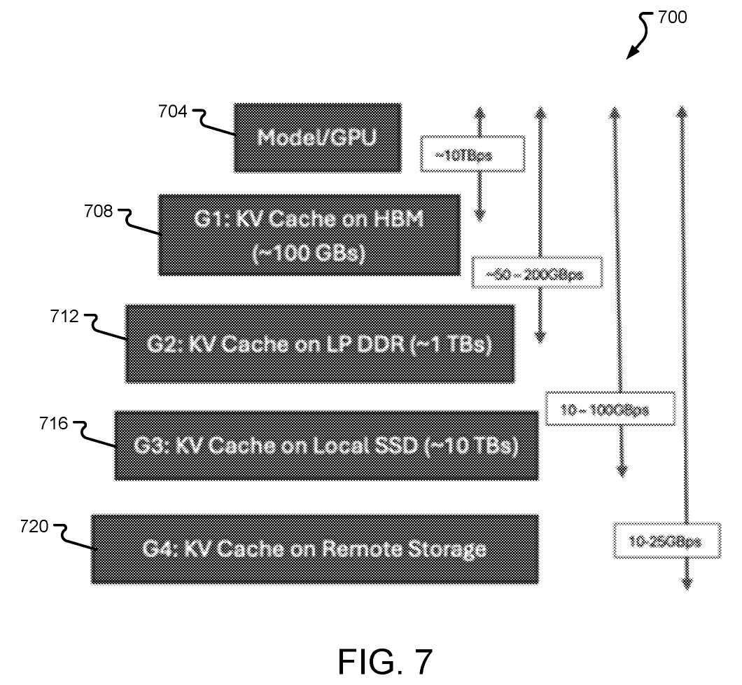

The KV cache store 512 may be hierarchical and can include a number of different storage endpoints having different capabilities. In some embodiments, the layers of the KV cache store 512 may include a memory pool 516, a block storage 520, file storage 522, and an object storage 524. As shown in further detail in FIG. 7, the hierarchy 700 of the KV cache store 512 may include different levels having different storage capacities and/or latencies associated therewith. As some non-limiting examples, the hierarchy 700 of the KV cache store 512 may include a first layer 704 (e.g., a model/GPU layer), a second layer 708 (e.g., a high-bandwidth memory layer), a third layer 712 (e.g., a Double Data Rate (DDR) SDRAM memory layer), a fourth layer 716 (e.g., a Solid State Drive (SSD)) layer), and a fifth layer 720 (e.g., a remote storage layer). Each layer of the hierarchy 700 may have various tradeoffs between capacity and latency. For instance, the first layer 704 may have the best available latency (e.g., storage and recall capabilities achievable at rates of 10TBps or more) as compared to other layers in the hierarchy 700, but may have the worst storage capability as compared to the other layers in the hierarchy 700.

Even though the different layers of the hierarchy 700 may be provided by different types of storage endpoints (e.g., different memory devices with different capabilities), the cache manager 356 may abstract the KV cache store 512 for the prefill workers 324 and the decode workers 336 such that data movements across the different levels of the hierarchy 700 are transparent to the workers 324, 336 and the users 304. In some embodiments, the cache manager 356 may be configured to provide a substantially uniform abstraction facilitating data movement between different types of storage endpoints such as block, local file, remote file, remote object, and cloud endpoints. This kind of abstraction allows context 504 and generation 508 phases (e.g., the prefill workers 324 and decode workers 336) to move data between different endpoints seamlessly.

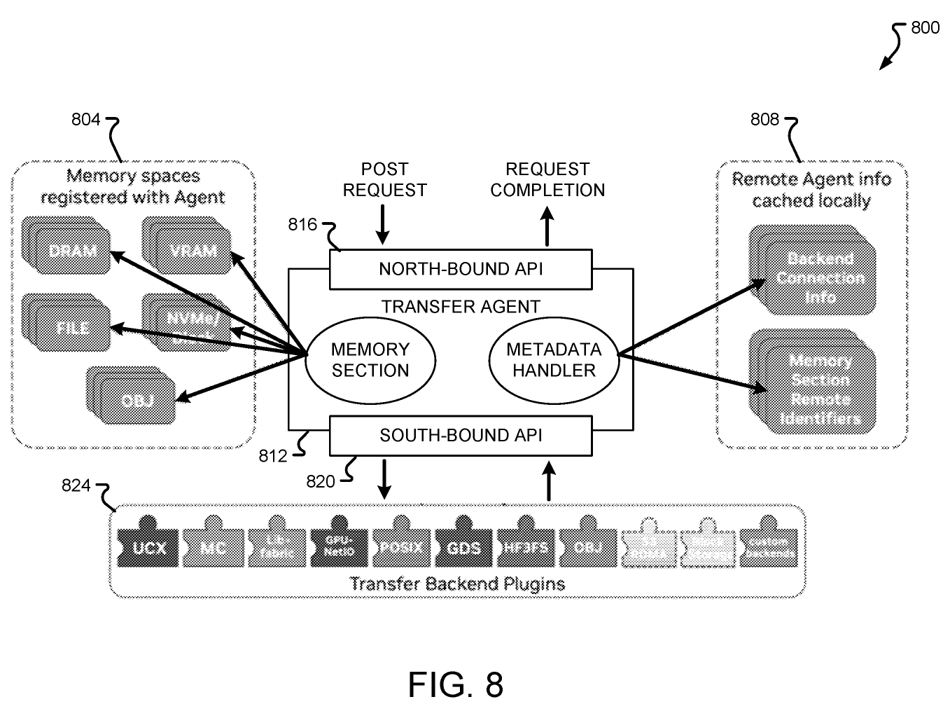

FIG. 8 illustrates additional details of a transfer library 800 and the capabilities of a cache manager 356 operating in the same. In some embodiments, the cache manager may include a transfer agent 812 to manage memory spaces 804 registered with agents and to manage remote agent information (e.g., metadata) 808. As a non-limiting example, the transfer agent 812 of the cache manager 356 may include a memory section to interact with the memory spaces 804 and a metadata handler to interact with the remote agent information 808.

The transfer agent 812 may transparently perform one-sided operations for the models 324, 336 using a first API 816 and a second API 820. The first API 816 may be application-facing, meaning that the first API 816 manages requests and completion notifications according to a predefined format. The second API 820 may be backend-facing, meaning that the second API 820 manages interactions with transfer backend plugins 824, which can be used to facilitate the transfer of data across different storage endpoints.

As previously noted, the transfer library depicted and described herein (and managed by the cache manager 356) may correspond to a high-throughput, low-latency point-to-point transfer library that provides a consistent data movement API (e.g., the second API 802). The second API 820 may be configured to move data rapidly and asynchronously across different tiers of memory and storage using common semantics. As a non-limiting example, the transfer agent 812 may be particularly configured for inference data movement, supporting nonblocking and noncontiguous data transfers between various types of memory and storage.

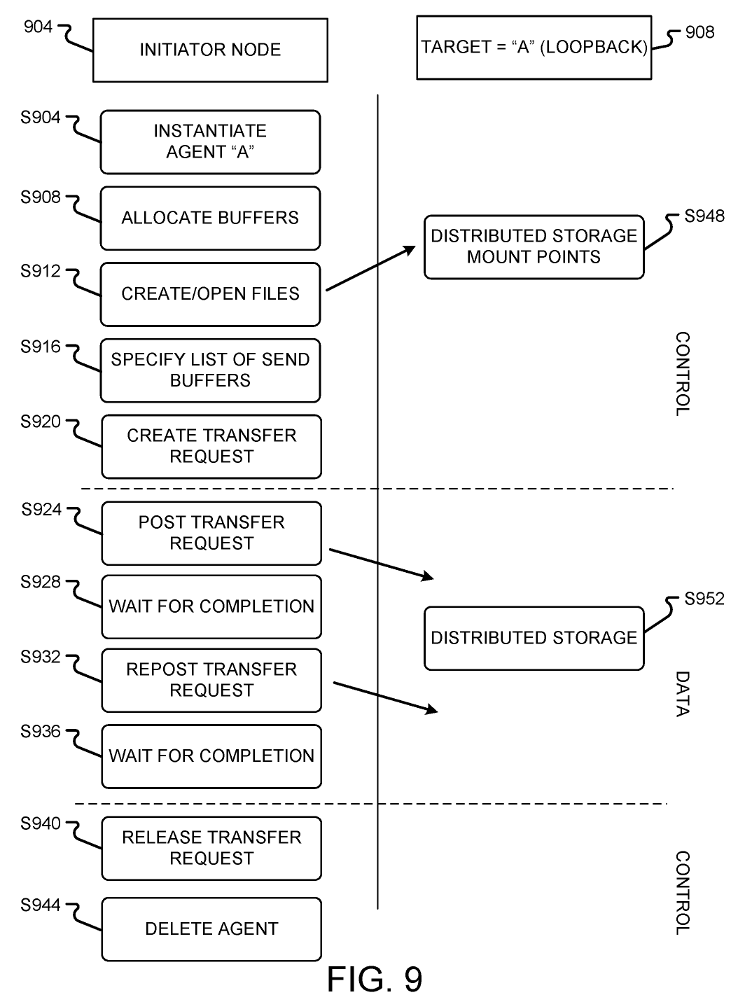

FIG. 9 illustrates additional details of interactions between an initiator node 904 and a target node 908 to facilitate a storage-related data transfer. In some embodiments, the data may be stored using RDMA or a similar approach in which a direct data path between storage and GPU memory is utilized. Such an approach may bypass CPU buffers, thereby reducing latency and lowering CPU utilization.

The example of FIG. 9 illustrates that the initiator node 904 first instantiates the target node 908 (step S904). Thereafter, the initiator node 904 allocates buffers (step S908). In some embodiments, allocating buffers may include registering memory (e.g., HBMs) with the initiator node 904 and/or target node 908.

The method may further include the initiator node 904 creating/opening files (sept S912), which invokes the target node 908 to identify distributed storage mount points for the data storage operation (step S948). The creation/opening of files may include registering the memory with an appropriate comment transmitted to the target node 908.

The method may further include the initiator node 904 specifying a list of send buffers within the GPUs (step S916). In addition to specifying send buffers, the list may include receive buffers without departing from the scope of the present disclosure.

The method may also include creating a transfer request for the buffer list(s) (step S920). For instance, the transfer request may include the specified send buffers and/or the specified receive buffers that will support the data storage operation.

The method may also include posting a transfer request (step S924). The transfer request may be posted to the target node 908 or to any other node wanting access to the data being stored in the distributed storage (step S952).

The method may further include waiting for completion of the transfer request (e.g., receiving an indication that the transfer was successful) (step S928). The posting of the transfer request and waiting for completion of the transfer request may be repeated (steps S932 and S936) until the entire transfer or data is completed.

The method may then include releasing the transfer request (step S940) and releasing the agent that was instantiated for the data transfer (step S944). In some embodiments, the agent may be deleted by deregistering the target node 908.

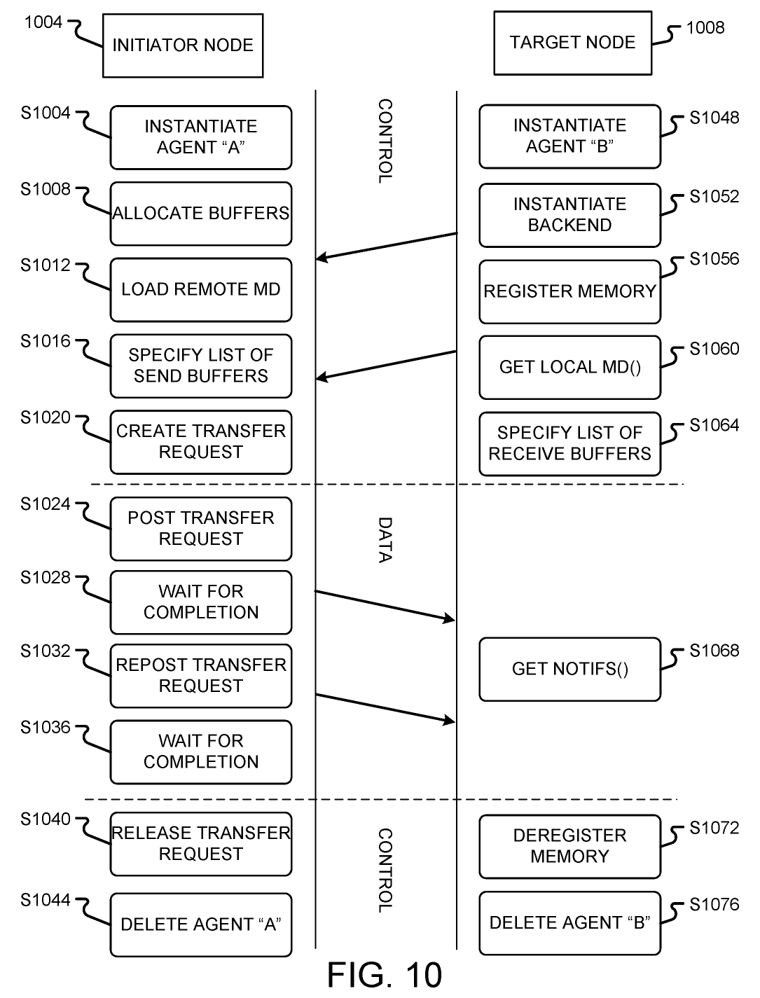

FIG. 10 illustrates additional details of interactions between an initiator node 1004 and a target node 1008 to facilitate a network-related data transfer. In some embodiments, the data may be transferred synchronously or asynchronously without departing from the scope of the present disclosure.

The example of FIG. 10 illustrates that the initiator node 1004 may instantiate a first agent (e.g., Agent “A”) (step S1004) while the target node instantiates a second agent (e.g., Agent “B”) (step S1048). As part of the agent instantiation, interactions with transfer backend plugins 824 may be instantiated at one or both nodes 1004, 1008 as well (step S1052).

The method may further include the initiator node 1004 allocating buffers (step S1008) by registering memory (e.g., HBMs) at the GPUs involved in the data transfer. In parallel, the target node 1008 may register memory (step S1056) and send Agent “B”s metadata to the initiator node 1004.

The target node 1008 may get a local memory device (step S1060) and specify a list of receive buffers (step S1064). The list of receive buffers may be sent to the initiator node while the initiator node 1004 simultaneously loads the remote memory device (step S1012) and specifies a list of send buffers (step S1016). The list of send buffers may be specified within all GPUs involved in the data transfer.

Thereafter, the initiator node 1004 may create a transfer request (step S1020) and then post the transfer request (step S1024) to the target node 1008. The initiator node 1004 will wait for completion of the data transfer (step S1028), which may include possible retries (steps S1032 and S1036). Meanwhile, the target node 1008 may receive the notifications from the initiator node (step S1068) and store the appropriate data at the local memory device. In some embodiments, multiple transfer requests can be posted back-to-back, meaning that transfer requests can be processed asynchronously.

Once the data has been transferred to the target node 1008, the initiator node 1004 may release the transfer request (step S1040) and release Agent “A” (step S1044). The target node 1008, on the other hand, may deregister its memory (step S1072) prior to deleting the Agent “B” (step S1076). Once the transfer request is completed and released and the agents are deleted, the data transfer may be considered complete.

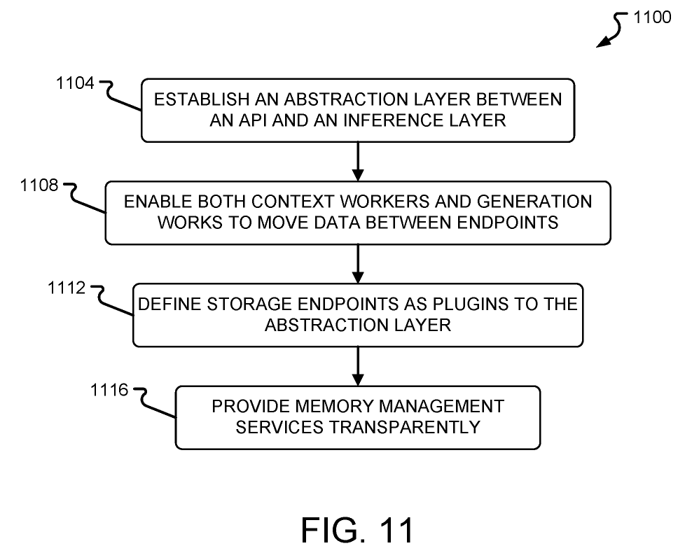

With reference now to FIG. 11, additional details of another method 1100 will be described in accordance with at least some embodiments of the present disclosure. The method 1100 may include establishing an abstraction layer between an API and an inference layer (step 1104).

In some embodiments, the abstraction layer may enable both context workers and generation workers to move data between different types of storage endpoints in a substantially transparent manner (step 1108).

The method 1100 may also include defining one or more storage endpoints as plugins to the abstraction layer (step 1112). As a non-limiting example, storage endpoints may be defined as part of a transfer backend 824, which is accessible to a transfer agent 812 via a second API 820. The method 1100 may further include providing memory management services to the context workers and the generation workers transparently (step 1116).

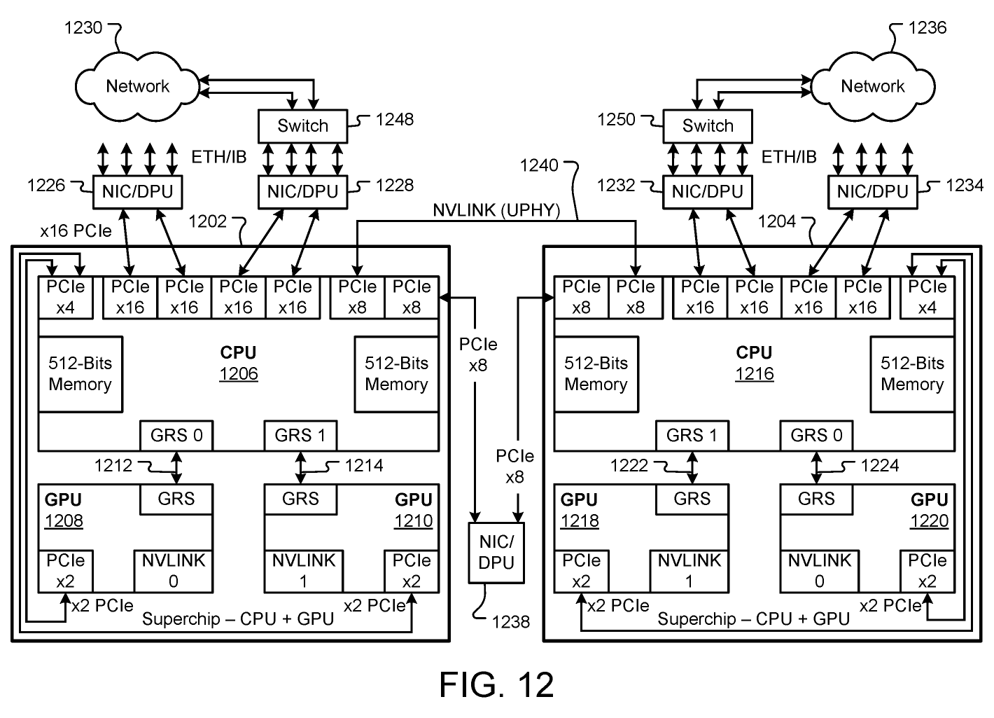

FIG. 12 depicts a block diagram that schematically illustrates a computing system 1200, e.g., a data center or a High-Performance Computing (HPC) cluster, in accordance with an embodiment that is described herein. The computing system 1200 comprises a plurality of subsystems, e.g. multiple processing devices coupled to each other, multiple network devices, and multiple networks, according to at least one embodiment. Computing system 1200 is designed with multiple integrated circuits (referred to as processing devices), where each integrated circuit can include one or more CPUs and GPUs, forming a powerful and flexible architecture. In some configurations, the sub-systems and/or the CPUs/GPUs of computing system 1200 may be implemented on circuit boards coupled via one or more bridge boards, which may be contained within one or more component housings. The removal of said bridge boards may utilize embodiments of the mechanisms disclosed herein.

The various processing devices are interconnected via an NVLink or other high-speed interconnect, enabling high-speed communication between the subsystems, and are also connected through a NIC or DPU (Data Processing Unit) to ensure efficient data transfer across computing system 1200 and to one or more external networks 1230, 1236. In the present example, system 1200 comprises a packet switch 1242 that connects NIC/DPU 1228 to network 1230, and a packet switch 1244 that connects NIC/DPU 1232 to network 1236.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1200 can include one or more CPUs and one or more GPUs.

FIG. 12 also depicts an example of a multi-GPU architecture. As depicted, computing system 1200 includes a processing device 1202 with a multi-GPU architecture. In particular, processing device 1202 may be a system-on-chip that includes multiple subsystems such as a CPU 1206, a GPU 1208, and a GPU 1210. CPU 1206 can be coupled to GPU 1208 via a die-to-die (D2D) or chip-to-chip (C2C) interconnect 1212, such as a Ground-Referenced Signaling interconnect (GRS interconnect). CPU 1206 can be coupled to GPU 1210 via a D2D or C2C interconnect 1214. CPU 1206 can also couple to GPU 1208 and GPU 1210 via PCIe interconnects.

CPU 1206 can be coupled to one or more NICs or DPUs, which are coupled to one or more networks. For example, as depicted in FIG. 12, CPU 1206 is coupled to a first NIC/DPU 1226, which is coupled to a network 1230. CPU 1206 is also coupled to a second NIC/DPU 1228, which is coupled to network 1230 via switch 1242. NIC/DPU 1226 and NIC/DPU 1228 can be coupled to network 1230 over Ethernet (ETH), NVLINK or InfiniBand (IB) connections, for example.

Computing system 1200 also includes a processing device 1204 with a multi-GPU architecture. In particular, processing device 1204 includes multiple subsystems including a CPU 1216, a GPU 1218, and a GPU 1220. CPU 1216 can be coupled to GPU 1218 via an D2D or C2C interconnect 1222. CPU 1216 can be coupled to GPU 1220 via a D2D or C2C interconnect 1224. CPU 1216 can also couple to GPU 1218 and GPU 1220 via PCIe interconnects. CPU 1216 can be coupled to one or more NICs or DPUs, which are coupled to one or more networks. For example, as illustrated in FIG. 12, CPU 1216 is coupled to a first NIC/DPU 1232, which is coupled to a network 1236. CPU 1216 is also coupled to a second NIC/DPU 1234, which is coupled to network 1236 via switch 1244. NIC/DPU 1232 and NIC/DPU 1234 can be coupled to network 1236 over Ethernet (ETH), NVLINK or InfiniBand (IB) connections.

In at least one embodiment, processing device 1202 and processing device 1204 may communicate with each other via a NIC/DPU 1238, such as over PCIe interconnects. Processing device 1202 and processing device 1204 may also communicate with each other over a high-bandwidth communication interconnects 1240, such as an NVLink interconnect or other high-speed interconnects. The packet switches in FIG. 12 may comprise, for example, Nvidia Quantum-2 switches. The NICs/DPUs in the figure may comprise, for example, Nvidia Bluefield DPUs.

Computing devices utilizing one or more graphic processing unit (GPU) and/or general purpose data processor (e.g., a 'central processing unit or CPU) may be configured with bridge boards, the removal of which may utilize embodiments of the mechanisms disclosed herein. Exemplary architectures will now be described that may be configured to implement the mechanisms disclosed herein.

The following description may use certain acronyms and abbreviations as follows:
"DPC" refers to a "data processing cluster";
"GPC" refers to a "general processing cluster";
"I/O" refers to a "input/output";
"L1 cache" refers to "level one cache";
"L2 cache" refers to "level two cache";
"LSU" refers to a "load/store unit";
"MMU" refers to a "memory management unit";
"MPC" refers to an "M-pipe controller";
"PPU" refers to a "parallel processing unit";
"PROP" refers to a "pre-raster operations unit";
"ROP" refers to a "raster operations";
"SFU" refers to a "special function unit";
"SM" refers to a "streaming multiprocessor";
"Viewport SCC" refers to "viewport scale, cull, and clip";
"WDX" refers to a "work distribution crossbar"; and
"XBar" refers to a "crossbar".

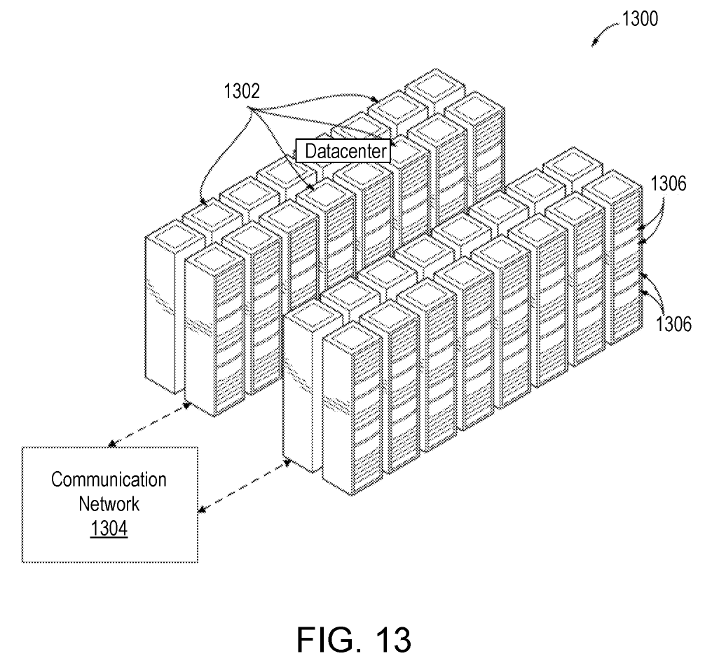

FIG. 13 illustrates an example of an architecture 1300 in which inference services may be provided in accordance with at least some embodiments of the present disclosure. The network architecture 1300 may include additional components and functionalities. For example, the network architecture 1300 may include, without limitation, additional processing units, specialized accelerators (such as Tensor Processing Units or TPUs), enhanced security modules, and redundant power supplies.

The inclusion of these elements may be intended to ensure that the network architecture 1300 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 1300.

The communication network 1304 of FIG. 13 may communicably couple the data center 1302 with network device(s) 1306 and other external devices for data exchange and connectivity. Examples of the communication network 1304 that may be used to connect the data center 1302 and the network device(s) 1306 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of the communication network 1304 to incorporate multiple network types and configurations may allow the data center 1302 to adapt to diverse application needs, from general data communication to specialized HPC tasks. As described herein, the communication network 1304 may leverage various optical components to establish communication links (e.g., communicably couple) between components in the architecture 1300. As such, the communication network 1304 may include various optical devices, transceivers, modules, and/or the like that are configured to generate optical signals (e.g., provide optical transmitter functionality) and/or receive optical signals (e.g., provide optical receiver functionality).

The network device(s) 1306 may include a variety of computing devices capable of transmitting and receiving signals over the communication network 1304. The network device(s) 1306 may range from personal computing devices to complex server configurations. Examples include Personal Computers (PCs), laptops, tablets, smartphones, and servers. The network device(s) 1306 may facilitate user interactions with the data center 1302, allowing for data input, retrieval, and processing from remote locations. In addition to individual computing devices, the network device(s) 1306 may also include collections of servers or additional datacenters. For instance, these could be other datacenters similar to or the same as data center 1302. Such an interconnection may allow for the formation of a distributed computing environment for improved redundancy, load balancing, and disaster recovery capabilities. By linking multiple datacenters, the network architecture 1300 may leverage geographically dispersed resources.

The communication network 1304 may communicably couple the data center 1302 with network device(s) 1306 and other external devices for data exchange and connectivity.

Each type of network offers specific advantages tailored to different operational requirements. For instance, an IP network or Ethernet network may provide widespread compatibility and ease of integration, supporting various protocols and applications across the data center 1302 and the network device(s) 1306 (and/or external devices). An InfiniBand network may offer high throughput and low latency, ideal for HPC environments where rapid data transfer and minimal delay are required. Fibre Channel networks may be employed for their robust performance in storage area networks (SANs), ensuring fast and reliable access to storage resources. Cellular and wireless communication networks may be used to extend connectivity to remote or mobile devices for increased flexibility and accessibility.

In one non-limiting example, the above-described properties may be achieved with inventive concepts by using InfiniBand (TB) transport and wire protocols. InfiniBand, which underpins state-of-the-art RDMA operations, comprises an all-hardware network transport used to connect supercomputers. InfiniBand has the potential to serve disaggregation traffic in that IB transport provides a reliable pipeline that also maintains in order delivery and, when combined with InfiniBand wire protocol and IB switches, end-to-end QoS and latency guarantees are provided even when the traffic needs to cross several switching layers (e.g., network switches). IB round-trip time (RTT) latency with one switching layer is in the area of 1 us, which is an acceptable latency given a comparison to a dedicated circuit network to perform the same task. In addition, IB NICs typically support the highest transceiver speeds in the industry. One current host attachment approach of IB NICs follows the traditional Direct Memory Access (DMA) engine-assisted integration with an OS-network stack (though many tasks have been offloaded in hardware).

The network device(s) 1306 may include a variety of computing devices capable of sending and receiving signals over the communication network 1304. The network device(s) 1306 can range from personal computing devices to complex server configurations. Examples include Personal Computers (PCs), laptops, tablets, smartphones, and servers. The network device(s) 1306 may facilitate user interactions with the data center 1302, allowing for data input, retrieval, and processing from remote locations. In addition to individual computing devices, the network device(s) 1306 may also include collections of servers or additional datacenters. For instance, these could be other datacenters similar to or the same as data center 1302. Such an interconnection may allow for the formation of a distributed computing environment for improved redundancy, load balancing, and disaster recovery capabilities. By linking multiple datacenters, the data center architecture 1300 can leverage geographically dispersed resources, optimizing performance and ensuring high availability.

The one or more network devices 1306 may include one or more of Personal Computer (PC), a laptop, a tablet, a smartphone, a server, a collection of servers, and/or any suitable computing device for sending and receiving signals over the communication network 1304. In at least one example embodiment, the one or more network devices 1306 correspond to another data center, similar to or the same as datacenter 1302.

As noted above, the data center 1302 and/or the network device(s) 1306 may include storage devices and/or processing circuitry for carrying out computing tasks, for example, tasks associated with controlling the flow of data internally and/or over the communication network 1304.

In addition, although not explicitly shown, it should be appreciated that the data center 1302 and network device(s) 1306 may include one or more communication interfaces for facilitating wired and/or wireless communication between one another and other unillustrated elements of the data center environment 1300. These communication interfaces may include a variety of technologies, including but not limited to Ethernet ports, fiber optic connections, Wi-Fi® transceivers, Bluetooth® modules, and cellular communication modules for integration and interoperability among the various components within the data center environment 1300. Furthermore, it should be understood that the data center environment 1300 may include additional components and functionalities within the scope of the present disclosure. These components may comprise, without limitation, additional processing units, specialized accelerators (such as Tensor Processing Units or TPUs), enhanced security modules, and redundant power supplies. The inclusion of these elements is intended to ensure that the data center environment 1300 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the data center environment 1300.

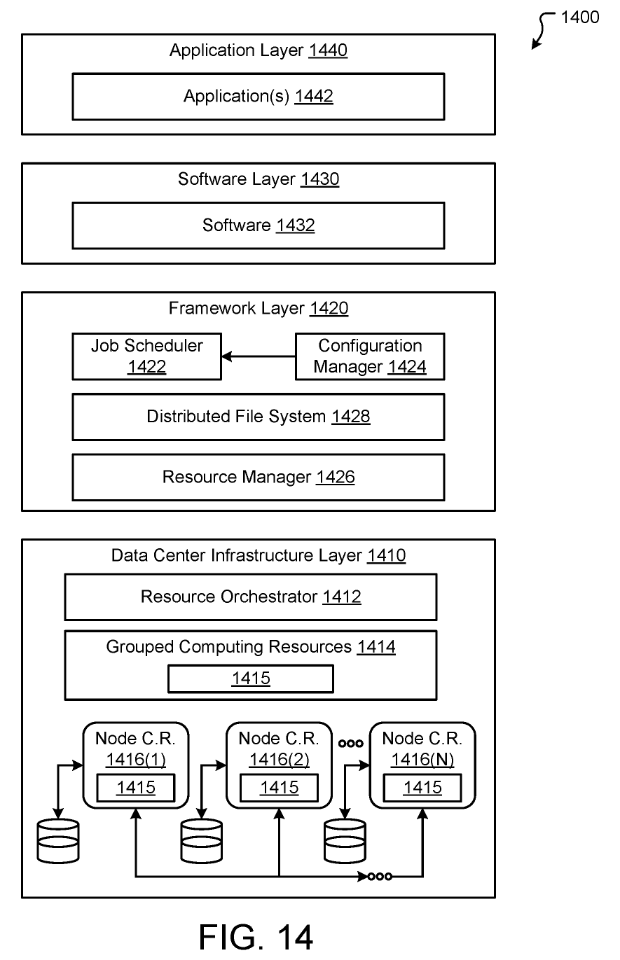

FIG. 14 illustrates additional details of data center layers 1400 and further corresponds to an environment in which a bridge removal tool may be utilized. FIG. 14 specifically illustrates an example data center 1400, in which at least one embodiment may be used. In at least one embodiment, data center 1400 includes a data center infrastructure layer 1410, a framework layer 1420, a software layer 1430 and an application layer 1440.

In at least one embodiment, as shown in FIG. 14, data center infrastructure layer 1410 may include a resource orchestrator 1412, grouped computing resources 1414, and node computing resources (“node C.R.s”) 1416(1)-1416(N), where “N” represents a positive integer (which may be a different integer “N” than used in other figures). In at least one embodiment, node C.R.s 1416(1)-1416(N) may include, but are not limited to, any number of central processing units (“CPUs”) or other processors (including accelerators, field programmable gate arrays (FPGAs), graphics processors, etc.), memory storage devices 1418(1)-1418(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 1416(1)-1416(N) may be a server having one or more of above-mentioned computing resources.

In at least one embodiment, grouped computing resources 1414 may include separate groupings of node C.R.s housed within one or more racks (not shown), or many racks housed in data centers at various geographical locations (also not shown). In at least one embodiment, separate groupings of node C.R.s within grouped computing resources 1414 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1412 may configure or otherwise control one or more node C.R.s 1416(1)-1416(N) and/or grouped computing resources 1414. In at least one embodiment, resource orchestrator 1412 may include a software design infrastructure (“SDI”) management entity for data center 1400. In at least one embodiment, resource orchestrator 1412 may include hardware, software or some combination thereof.

In at least one embodiment, as shown in FIG. 14, framework layer 1420 includes a job scheduler 1422, a configuration manager 1424, a resource manager 1426 and a distributed file system 1428. In at least one embodiment, framework layer 1420 may include a framework to support software 1432 of software layer 1430 and/or one or more application(s) 1442 of application layer 1440. In at least one embodiment, software 1432 or application(s) 1442 may respectively include web-based service software or applications, such as those provided by Amazon Web Services, Google Cloud and Microsoft Azure. In at least one embodiment, framework layer 1420 may be, but is not limited to, a type of free and open-source software web application framework such as Apache Spark™ (hereinafter “Spark”) that may use distributed file system 1428 for large-scale data processing (e.g., “big data”). In at least one embodiment, job scheduler 1422 may include a Spark driver to facilitate scheduling of workloads supported by various layers of data center 1400. In at least one embodiment, configuration manager 1424 may be capable of configuring different layers such as software layer 1430 and framework layer 1420 including Spark and distributed file system 1428 for supporting large-scale data processing. In at least one embodiment, resource manager 1426 may be capable of managing clustered or grouped computing resources mapped to or allocated for support of distributed file system 1428 and job scheduler 1422. In at least one embodiment, clustered or grouped computing resources may include grouped computing resources 1414 at data center infrastructure layer 1410. In at least one embodiment, resource manager 1426 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1428 of framework layer 1420. In at least one embodiment, one or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1428 of framework layer 1420. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1424, resource manager 1426, and resource orchestrator 1412 may implement any number and type of self-modifying actions based on any amount and type of data acquired in any technically feasible fashion. In at least one embodiment, self-modifying actions may relieve a data center operator of data center 1400 from making possibly bad configuration decisions and possibly avoiding underused and/or poor performing portions of a data center.

In at least one embodiment, data center 1400 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1400. In at least one embodiment, trained machine learning models corresponding to one or more neural networks may be used to infer or predict information using resources described above with respect to data center 1400 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Within this disclosure, different entities (which may variously be referred to as "units," "circuits," other components, etc.) may be described or claimed as "configured" to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be "configured to" perform some task even if the structure is not currently being operated. A "credit distribution circuit configured to distribute credits to a plurality of processor cores" is intended to cover, for example, an integrated circuit that has circuitry that performs this function during operation, even if the integrated circuit in question is not currently being used (e.g., a power supply is not connected to it). Thus, an entity described or recited as "configured to" perform some task refers to something physical, such as a device, circuit, memory storing program instructions executable to implement the task, etc. This phrase is not used herein to refer to something intangible.

The term "configured to" is not intended to mean "configurable to." An unprogrammed FPGA, for example, would not be considered to be "configured to" perform some specific function, although it may be "configurable to" perform that function after programming.

Reciting in the appended claims that a structure is "configured to" perform one or more tasks is expressly intended not to invoke 35 U.S.C. § 112(f) for that claim element. Accordingly, claims in this application that do not otherwise include the "means for" [performing a function] construct should not be interpreted under 35 U.S.C § 112(f).

As used herein, the terms "first," "second," etc. are used as labels for nouns that they precede, and do not imply any type of ordering (e.g., spatial, temporal, logical, etc.), unless stated otherwise. For example, in a register file having eight registers, the terms "first register" and "second register" can be used to refer to any two of the eight registers, and not, for example, just logical registers 0 and 1.

When used in the claims, the term "or" is used as an inclusive or and not as an exclusive or. For example, the phrase "at least one of x, y, or z" means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system, comprising:
a Key and Value (KV) cache store having an abstraction layer facilitating data movement between different types of storage endpoints.

2. The system of claim 1, wherein the abstraction layer enables both context workers and generation workers in a Large Language Model (LLM) to move data between different storage endpoints.

3. The system of claim 2, wherein the different storage endpoints are defined as plugins to the abstraction layer to enable the movement of data between the storage endpoints.

4. The system of claim 2, wherein the different storage endpoints comprise at least one of block endpoints, local file endpoints, remote file endpoints, remote object endpoints, and cloud endpoints.

5. The system of claim 1, wherein the KV cache comprises at least one of a memory pool, a block storage, file storage, and an object storage.

6. A transfer library, comprising:
a Key and Value (KV) cache; and
an abstraction layer that utilizes the KV cache to facilitate transparent data movement for context workers and generation workers in a Large Language Model (LLM).

7. The transfer library of claim 6, wherein a cache manager cooperates with an inference transfer engine to move data for the context workers and for the generation workers between different storage endpoints depending upon a predicted need for such data.

8. The transfer library of claim 7, wherein the KV cache comprises a distributed KV cache that includes at least one of a memory pool, a block storage, a file storage, and an object storage.

9. The transfer library of claim 8, wherein the KV cache stores intermediate states of inference generated by at least one of the context workers and the generation workers.

10. The transfer library of claim 8, wherein the context workers and the generation workers are executed on different processing nodes.

11. The transfer library of claim 10, wherein the different processing nodes comprise at least one of a Graphics Processing Unit (GPU), a Central Processing Unit (CPU), a Data Processing Unit (DPU), and a Quantum Processing Unit (QPU).

12. The transfer library of claim 6, wherein the abstraction layer is implemented as a transfer agent having a first Application Programming Interface (API) to manage requests and completions and a second API to manage interactions with the KV cache.

13. The transfer library of claim 6, wherein the context workers perform a prefill phase of inference and the generation workers perform a decode phase of inference.

14. The transfer library of claim 13, wherein the LLM comprises at least one of a generative Large Language Model (LLM) and a reasoning model.

15. A computing environment, comprising:
a Key and Value (KV) cache;
one or more models to provide an inference service; and
a cache manager that transparently performs one-sided operations for the one or more models using the KV cache to facilitate network-related data transfers and storage-related data transfers across different storage endpoints.

16. The computing environment of claim 15, wherein the one or more models are distributed across a plurality of different nodes.

17. The computing environment of claim 16, wherein the one or more models provide a prefill phase of inference and a decode phase of inference.

18. The computing environment of claim 16, wherein the cache manager utilizes the KV cache to offload the network-related data transfers and the storage-related data transfers across different memory hierarchies.

19. The computing environment of claim 18, wherein the different memory hierarchies include at least a first memory hierarchy and a second memory hierarchy, wherein the first memory hierarchy comprises a first capacity and a first retrieval speed associated therewith, wherein the second memory hierarchy comprises a second capacity and a second retrieval speed associated therewith, wherein the first capacity is less than the second capacity, and wherein the first retrieval speed is faster than the second retrieval speed.

20. The computing environment of claim 15, wherein the different storage endpoints are provided as different transfer backend plugins that are accessible to the cache manager via an Application Programming Interface (API) that defines a structure for the one-sided operations.
